(19) United States
(12) Patent Application Publication
(10) Pub. No.: US 2014/0112589 A1
(43) Pub. Date: Apr. 24, 2014

(54) ENCODER, DECODER AND METHOD

(71) Applicant: GURULOGIC MICROSYSTEMS OY, Turku (FI)

(72) Inventors: Ossi Mikael KALEVO, Toijala (FI); Tuomas Kärkkäinen, Turku (FI)

(73) Assignee: GURULOGIC MICROSYSTEMS OY, Turku (FI)

(21) Appl. No.: 13/657,382

(22) Filed: Oct. 22, 2012

(30) Foreign Application Priority Data
Oct. 22, 2012 (GB) 1218942.9

(51) Int. Cl. G06K 9/36

(52) U.S. Cl. 382/233; 382/232

(57) ABSTRACT

An encoder encodes input data to generate corresponding encoded output data. The encoder includes an analysis unit for analysing a portion of the input data and directing the portion to appropriate encoding unit(s), wherein the encoding unit(s) are operable to encode the portion thereat to generate the encoded output data. At least one of the encoding units is operable to compute an average value of data values present in each portion received thereat, to subdivide the data values into at least two sets, to compute average values of the data values in each set, and for each set to allocate the average value for that set to all data values in that set, whilst retaining a spatial mask of the portion, and wherein the spatial mask and information representative of the average values computed for the at least two data sets is included in the encoded output data.

### FIELD OF THE INVENTION

The present invention relates to encoders for encoding data corresponding to a variety of content, for example still images, video content, graphics content, audio content, measurement data and so forth, for generating corresponding encoded output data. Moreover, the present invention concerns methods of encoding data corresponding to a variety of content, for example still images, video content, graphics content, audio content, measurement data and so forth, for generating corresponding encoded output data. Furthermore, the present invention relates to decoders for decoding data in an encoded format generated by the aforesaid encoders. Additionally, the present invention is concerned with methods of decoding data generated by aforesaid encoders. Yet additionally, the present invention relates to software products recorded on machine-readable data storage media, wherein the software products are executable upon computing hardware for implementing aforementioned methods.

### BACKGROUND OF THE INVENTION

There are many contemporary known methods of encoding data, and also decoding the encoded data. Nevertheless, there is a lack of a method of encoding data which is suitable for a broad range of content represented by the data to be encoded, for example still images, video content, audio content or graphics data. Such encoding has as its primary aim to generate encoded output data which is more compact than corresponding input data to be encoded. Moreover, there is also a lack of a corresponding decoder for decoding such encoded data.

Image encoding methods such as JPEG (“Joint Photographic Experts Group”, namely lossy DCT-based coding, wherein “DCT” is an abbreviation for Discrete Cosine Transform), JPEG2000 (“Joint Photographic Experts Group”, namely wavelet-based encoding) and WebP (image format encoding which employs both lossy and lossless compression during encoding) are known to be well adapted for compressing natural image content, but are less suitable for compressing text or images whose colours are described by only a few colour values and whose content has a relatively high spatial frequency component. An alternative known method of encoding data is referred to as GIF (“Graphics Interchange Format”) and employs a palette-based compression algorithm which is well adapted to encode images that can be presented with a relative small number of colour values required to render the images, for example 256 colour values; however, if the images to be encoded by GIF algorithms include natural objects having subtle spatially-gradual colour variations, GIF creates undesirable artefacts which are noticeable in corresponding decoded GIF images. Known contemporary PNG encoding (“Portable Networks Graphics”, lossless encoding) is generally similar to GIF encoding and provides more options for encoding image data, but is not nevertheless well adapted for images which contain a small range of colour values. Other known encoding methods employ text encoding using OCR (“Optical Character Recognition”) in combination with encoding characters; OCR is sometimes an appropriate method to employ, but is sensitive to positioning of text within an image, tilting of text within the image, a font of the text and also an object in which the text is located; additionally, OCR can potentially require considerable processing power for its implementation.

More recently, scientific publications have proposed yet alternative encoding methods which are suitable for encoding data which is in a bi-level block data sequence format; details of these scientific publications are provided in Table 1.

TABLE 1
Encoding methods for encoding data in bi-level block data sequence format.

| Title of publication | Authors | Publication details |
|---|---|---|
| “A bi-level block coding | Li Tan and Jean | Proceedings of the 2008 IAJC-IJME |
| technique for encoding data | Jiang | International Conference, International Journal |
| sequences with sparse | | of Modern Engineering (IJME), paper 185, ENT |
| distribution” | | 201. |
| | | ISBN 978-1-60643-379-9 |
| “Lossless compression of | S. D. Stearins, L. Tan, | IEEE Transactions on Geoscience and Remote |
| waveform data for efficient | and N. Magotra | Sensing, |
| transmission and storage” | | Vol. 31, no. 3, pp 645-654, May 1993 |
| “A block coding technique | G. Zeng and N. Ahmed | IEEE Transactions on Acoustics, Speech and |
| for encoding sparse binary | | Signal Processing, |
| patterns” | | Vol. 37, no. 5, pp 778-780, May 1989 |

Aforesaid known methods of encoding data, and corresponding known methods of decoding such encoded data, are not well adapted for a broad range of content represented by the data, despite the known methods employing a wide range of mutually different approaches. Despite considerable research over many years to evolve more efficient encoding algorithms to provide improved data compression, namely an issue of great importance to communication systems handling streamed video content, an optimal encoding method has yet to be devised.

### SUMMARY OF THE INVENTION

The present invention seeks to provide an improved method of encoding input data to generate corresponding encoded output data, for example encoded output data which is compressed relative to its corresponding input data.

The present invention also seeks to provide an encoder which employs an improved method of encoding input data to generate corresponding encoded output data, for example encoded output data which is compressed relative to its corresponding input data.

The present invention seeks to provide an improved method of decoding data generated from encoders pursuant to the present invention.

The present invention seeks to provide an improved decoder for decoding data generated from encoders pursuant to the present invention.

According to a first aspect of the present invention, there is provided an encoder as claimed in appended claim 1: there is provided an encoder for encoding input data to generate corresponding encoded output data, characterized in that the encoder includes an analysis unit for analysing one or more portions of the input data and directing the one or more portions to appropriate one or more encoding units, wherein the one or more encoding units are operable to encode the one or more portions thereat to generate the encoded output data, wherein at least one of the one or more encoding units is operable to compute an average value of data values present in each portion received thereat, to subdivide the data values into at least two sets, to compute average values of the data values in each set, and for each set to allocate the average value for that set to all data values in that set, whilst retaining a spatial mask of the portion, and wherein the spatial mask and information representative of the average values computed for the at least two data sets are included in the encoded output data.

The present invention is of advantage in that the encoder is operable to compute averages of sets and masks defining layouts of portions of the input data for inclusion in output encoded data from the encoder which provides for efficient encoding of certain types of content present in the input data.

Optionally, the encoder includes an output encoder unit for receiving encoded output data from the one or more encoding units and for further encoding this encoded output data to generate the encoded output data from the encoder.

Optionally, the encoder further includes an input stage for partitioning the input data to one or more portions when the input data is not already subdivided into one or more portions.

Optionally, in the encoder, the average value is at least one of: an arithmetic average, a skewed average, a logarithmic average, a weighted average.

Optionally, in the encoder, the at least one of the one or more encoding units is operable to subdivide the data values present in each portion into a range of 2 to 8 data sets, or into 2 or more data sets. A portion corresponds to a data block of an image, for example. For example, 8 data sets are optionally used for 8-bit binary data.

Optionally, the encoder is operable to store information representative of the one or more masks of the one or more portions in a remote database for access by one or more decoders when decoding the encoded output data generated by the encoder.

According to a second aspect of the invention, there is provided a method of encoding input data to generate corresponding encoded output data, characterized in that the method includes
(a) using an analysis unit for analysing one or more portions of the input data and directing the one or more portions to appropriate one or more encoding units, wherein the one or more encoding units are operable to encode the one or more portions thereat to generate the encoded output data; and
(b) using at least one of the one or more encoding units to compute an average value of data values present in each portion received thereat, to subdivide the data values into at least two sets, to compute average values of the data values in each set, and for each set to allocate the average value for that set to all data values in that set, whilst retaining a spatial mask of the portion, and wherein the spatial mask and information representative of the average values computed for the at least two data sets are included in the encoded output data.

Optionally, the method includes using an output encoder unit for receiving encoded output data from the one or more encoding units and for further encoding this encoded output data to generate the encoded output data.

Optionally, the method includes employing an input stage for partitioning the input data to one or more portions when the input data is not already subdivided into one or more portions.

Optionally, in the method, the average value is at least one of: an arithmetic average, a skewed average, a logarithmic average, a weighted average.

Optionally, the method includes using at least one of the one or more encoding units to subdivide the data values present in each portion into a range of 2 to 8 data sets.

Optionally, the method includes storing information representative the one or more masks of the one or more portions in a remote database for access by one or more decoders when decoding the encoded output data.

According to a third aspect of the invention, there is provided a decoder for decoding encoded input data to generate corresponding decoded output data, characterized in that the decoder includes

an analysis unit for analysing one or more portions of the input data and directing the one or more portions to appropriate one or more decoding units, wherein the one or more decoding units are operable to decode the one or more portions thereat for generating the decoded output data, wherein
at least one of the one or more decoding units is operable to extract a spatial mask and information representative of average values computed for at least two data sets included in the encoded input data, and for assigning average values to elements in the mask pursuant to which of the sets the elements belong as defined by the mask.

Optionally, the decoder includes an output decoder unit for receiving decoded output data from the one or more decoding units and for further decoding this encoded output data to generate the decoded output data from the decoder.

Optionally, the decoder further includes an input stage for extracting from the encoded input data one or more portions for directing as defined by encoding parameters present in the encoded input data to one or more decoding units.

Optionally, the decoder is implemented such that the average value is at least one of: an arithmetic average, a skewed average, a logarithmic average, a weighted average. Other types of average are also possible.

Optionally, the decoder is implemented such that the at least one of the one or more decoding units is operable to assign average values to elements of the mask corresponding the data sets, wherein there are in a range of 2 to 8 data sets, or to 2 or more data sets. For example, 8 data sets are optionally used for 8-bit binary data

Optionally, the decoder is operable to retrieve information representative the one or more masks of the one or more portions from a remote database when decoding the encoded input data generated by an encoder.

According to a fourth aspect of the invention, there is provided a method of decoding encoded input data to generate corresponding decoded output data, characterized in that the method includes
(a) using an analysis unit for analysing one or more portions of the encoded input data and directing the one or more portions to appropriate one or more decoding units, wherein the one or more decoding units are operable to decode the one or more portions thereat for generating the decoded output data; and
(b) using at least one of the one or more decoding units to extract a spatial mask and information representative of average values computed for at least two data sets included in the encoded input data, and to assign average values to elements in the mask pursuant to which of the sets the elements belong as defined by the mask.

Optionally, the method includes using an output decoder unit for receiving decoded output data from the one or more decoding units and for further decoding this encoded output data to generate the decoded output data.

Optionally, the method further includes using an input stage for extracting from the encoded input data one or more portions for directing as defined by encoding parameters present in the encoded input data to one or more decoding units.

Optionally, when using the method, the average value is at least one of: an arithmetic average, a skewed average, a logarithmic average, a weighted average.

Optionally, when using the method, the at least one of the one or more decoding units is operable to assign average values to elements of the mask corresponding the data sets, wherein there are in a range of 2 to 8 data sets, or to 2 or more data sets. Such an example is beneficially used for 8-bit binary data, although further 16-bit, 32-bit and so forth binary data is optionally used.

Optionally, the method includes retrieving information representative the one or more masks of the one or more portions from a remote database when decoding the encoded input data generated by an encoder.

According to a sixth aspect of the invention, there is provided a data communication system including at least one encoder pursuant to the first aspect of the invention for encoding input data and generating corresponding encoded data, and including at least one decoder pursuant to the third aspect of the invention for decoding the encoded data to generate decoded output data.

According to a seventh aspect of the invention, there is provided a method of communicating data in a data communication system pursuant to the sixth aspect of the invention, wherein the method of communicating data utilizes a combination of a method pursuant to the second aspect of the invention, and a method pursuant to the fourth aspect of the invention.

According to a seventh aspect of the invention, there is provided a software product recorded on machine-readable data storage media, characterized in that the software product is executable upon computing hardware for executing a method pursuant to the second aspect of the invention.

According to an eighth aspect of the invention, there is provided a software product recorded on machine-readable data storage media, characterized in that the software product is executable upon computing hardware for executing a method pursuant to the fourth aspect of the invention.

It will be appreciated that features of the invention are susceptible to being combined in various combinations without departing from the scope of the invention as defined by the appended claims.

### DESCRIPTION OF THE DIAGRAMS

Embodiments of the present invention will now be described, by way of example only, with reference to the following diagrams wherein:

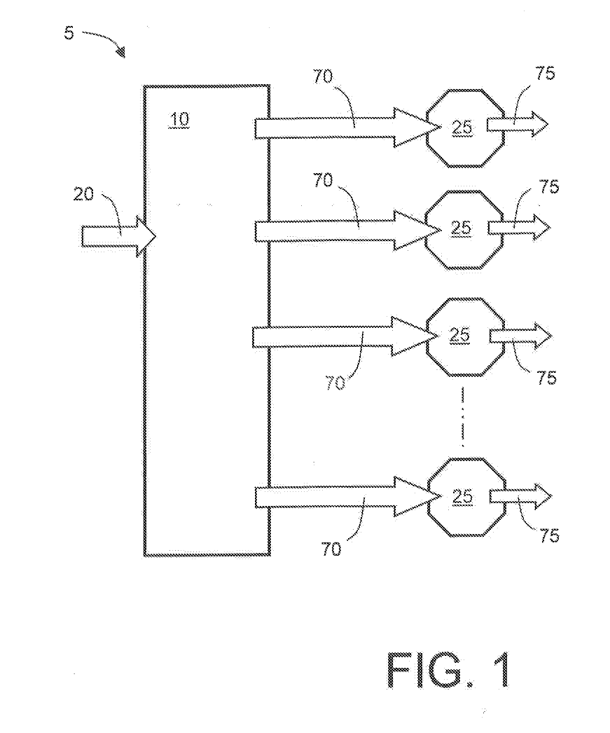

FIG. 1 is an illustration of an encoder and a decoder pursuant to the present invention;

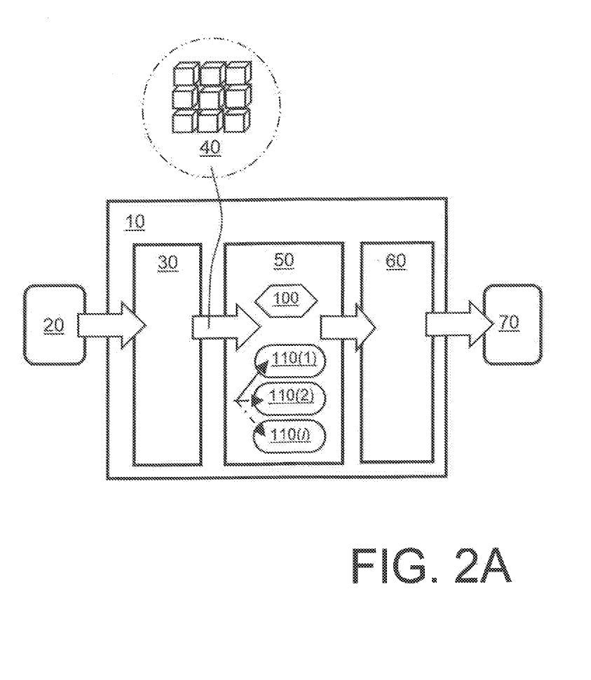

FIG. 2A is a schematic illustration of an encoder for implementing a method of encoding input data pursuant to the present invention;

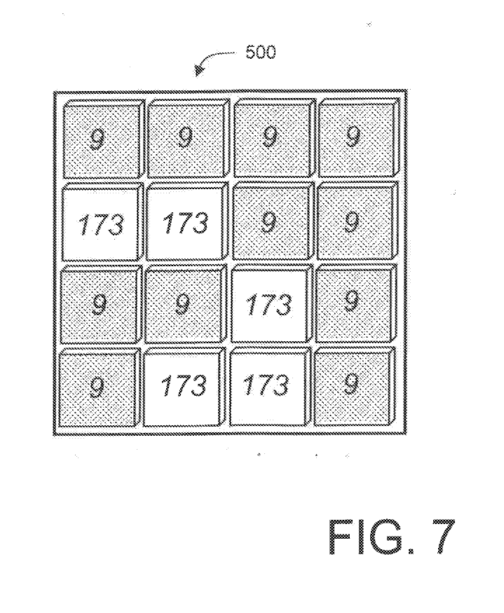

FIG. 28 is a schematic illustration of a decoder for implementing a method of decoding input data which has been encoded pursuant to the present invention;

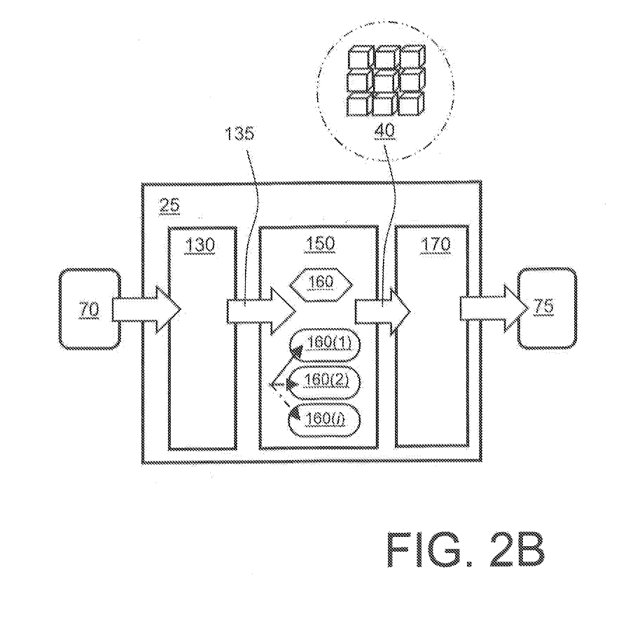

FIG. 3 is a schematic illustration of a second encoding stage of the encoder of FIG. 2A;

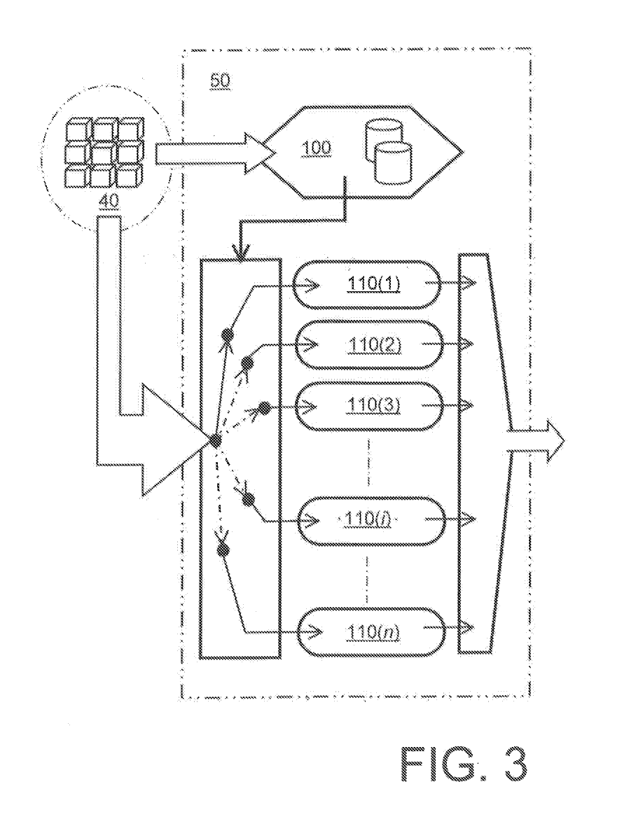

FIG. 4 is an illustration of subdividing image data into data blocks, namely portions, for encoding in the second encoding stage of the encoder of FIG. 2A;

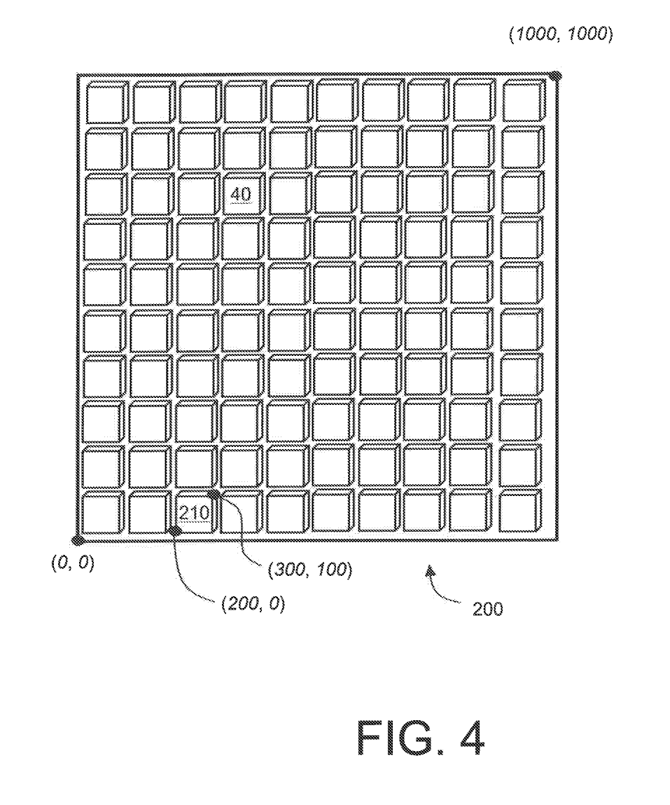

FIG. 5 is an illustration of a data block to be encoded using the encoder of FIG. 2A;

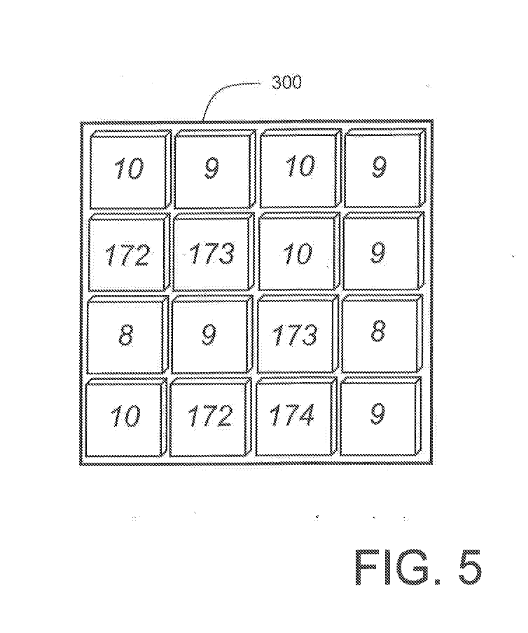

FIG. 6 is an illustration of a mask for the data block of FIG. 5, after computation of average values for sets of levels employed to represent the data block of FIG. 5; and

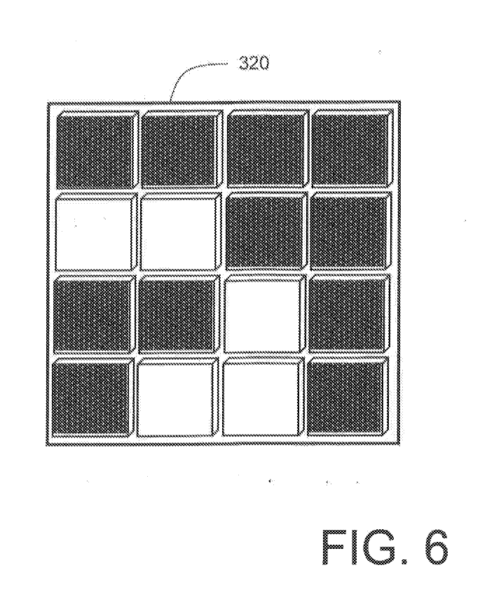

FIG. 7 is an illustration of a regenerated decoded data block derived from encoded data generated by the encoder of FIG. 2A.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the none underlined number is used to identify a general item at which the arrow is pointing.

### DESCRIPTION OF EMBODIMENTS OF THE INVENTION

In overview, the present invention is concerned with an improved method of encoding input data to generate corresponding encoded output data, wherein the method is capable of providing an enhanced degree of coding efficiency. The improved method is capable of efficiently coding a wide range of content represented in the input data, for example still images, video content, graphics content, audio content, ECG (“electrocardiogram”), seismic data and so forth.

Referring to FIG. 1, there is provided an illustration of an encoder 10 which is operable to encode input data 20 using a method pursuant to the present invention. The encoder 10 generates encoded output data 70 which can be stored and/or streamed for subsequent decoding at one or more decoders 25. The one or more decoders 25 are operable to generate corresponding decoded data 75 for consumption by one or more users. The decoded data 75 corresponds substantially to the input data 20. A combination of at least one encode 10 and at least one corresponding decoder 25 forms a data communication system indicated generally by 5.

Referring to FIG. 2A, there is provided an illustration of the encoder 10 which is operable to encode the input data 20 using a method pursuant to the present invention. The encoder 10 employs a first stage 30 which partitions the input data 20 into data blocks 40, if the input data 20 is not already in a data block format. In a second stage 50, the encoder 10 processes each data block 40 and sorts its data into at least two levels as well as generating a mask describing which data values in the data block 40 belong to which corresponding level, as well as computing mean values of the data sorted into each level. The mask is beneficially implemented as a spatial bit map. In a third stage 60 involves compressing the bitmap as well as the mean values for each level to generate encoded output data 70 from the encoder 10; different compression algorithms are optionally employed for the third stage 60, for example RLE (“Run-length encoding”) DPCM (“Differential pulse-code modulation”), VLC (“Variable-length coding”). Optionally, the encoder 10 can be employed in combination with other encoders for achieving hybrid encoding of the input data 20 to generate encoded output data 70, for example DCT, palette, DPCM. In practice, the term “level” can correspond to one or more of: a chrominance level, a luminance level, a colour value, a brightness, an amplitude, a frequency, an intensity; however, “level” can also include other parameters describing physical variables depending upon a nature of the input data 20.

In the first stage 30, the data blocks 40 can vary in size, depending upon a nature of content present in the input data 20. The input data 20 is optionally 1-dimensional, for example audio content, ECG-data (Electrocardiography), seismic data. Alternatively, the input data 20 is multi-dimensional, for example still images, video content, graphics content, 3D image/video/graphics. Moreover, 2-dimensional input data includes, for example, square, triangle, circle, and similar elements, namely optionally any form of 2-dimensional geometrical shape. Furthermore, 3-dimensional image data includes, for example, elements which are cubic, pyramid, cylinder, ball-shaped, and so forth. When the input data 20 includes spatially high frequency components and only a few levels to define spatial elements represented in the input data 20, contemporary known encoding methods are especially ineffective, but are processed efficiently in the encoder 10. Optionally, the encoder 10 is capable of encoding the input data 20 as original data or formed by way of pre-encoding processing, for example DPCM, motion estimation, spatial prediction.

In the second stage 50 of the encoder 10, a compression method pursuant to the present invention is employed as illustrated in FIG. 3. Data blocks 40 from the first stage 30 are analyzed in an analysis unit 100 to determined a most appropriate encoding algorithm to employ for encoding the data blocks 40; depending upon the analysis executed by the analysis unit 100, the data blocks are directed to one or more encoding units 110(1) to 110(n), wherein n is an integer and describes a total number of different coding algorithms employed within the second stage 50. The analysis unit 100 analyses a number of different colours present in the data blocks 40 and spatial frequency information present in the data blocks 40 for purposes of deciding which encoding unit 110 is optimal to employ for encoding a given type of data block 40. The encoding units 110 optionally employ one or more of: DC (“Direct Current”) encoding, slide encoding, DCT (“discrete cosine transform”) wavelet encoding, palette encoding database encoding, VQ (“vector quantization”) encoding. In encoded output data from the second stage 50, there is included data indicative of which of the encoder units 110 have been employed for any given data block 40. At least one encoding unit 110(i) of the encoding units 110, wherein an integer i is in a range 1 to n, employs a coding algorithm pursuant to the present invention which will be described in more detail later. Optionally, sizes of the data blocks 40 can vary in a data stream provided from the first stage 30, wherein information provided to the second stage 50 also includes information which is spatially indicative of where the data blocks 40 are included in any one or more given images; such information is included in encoded output data provided from the second stage 50; such inclusion of data-block position indicative data is beneficially implemented as described in United Kingdom patent application no. GB1214414.2 (encoder) and U.S. patent application Ser. No. 13/584,047 (decoder), these applications being hereby incorporated by reference. Alternatively, such inclusion is beneficially implemented in the third stage 60. Sizes of the data-blocks can be presented with numbers such as height×width expressed in pixels. Spatial positions of the data-blocks are beneficially defined as co-ordinates relative to the image such as x, y pixels from a corner of the image.

Referring to FIG. 2B, the decoder 25 corresponding to the encoder 10 is shown. The decoder 25 includes a first decoding stage 130 which is operable to receive the encoded data 70 and to execute upon the encoded data 70 an inverse of encoding applied by third stage 60 of the encoder 10 for generate intermediate decoded data denoted by 135. The intermediate decoded data includes information such as which type of encoding unit 110 was employed to encode a given data block 40, mask for the data block 40, average value where appropriate, and so forth. The decoder 25 further includes a second stage 150 which includes one or more decoder units 160 corresponding to an inverse of the encoder units 110, wherein encoded data blocks present in the intermediate decoded data 135 are directed to appropriate decoder units 160 included in the second stage to regenerate the data blocks 40 within the decoder 25. The decoder 25 further includes a third stage 170 which is operable to apply an inverse of operations performed in the first stage 30 of the encoder 10, for generating the decoded output data 75 corresponding substantially to the input data 20. Additionally, or alternatively, spatial and size information of data blocks 40 are optionally generated in a first decoding stage 130. The spatial and position information is beneficially further sent to the second stage 150 in order to enable the third stage 170 to place data blocks in appropriate spatial position.

The encoding algorithm pursuant to the present invention is susceptible to being employed to encode data blocks 40 of any size, although it is beneficially employed for encoding data blocks 40 including in a range of 8 to 256 elements or values, for example pixels. Moreover, the coding algorithm is conveniently referred to as being a multilevel coding method. A first and most useful implementation of the algorithm employs two levels, for example colours although not limited thereto as aforementioned, and is optimized to encode subject matter such as code command prompts, text and other content that include only two levels. However, it is optionally feasible to implement the algorithm to encode more than two levels; beneficially, the number of levels into which data blocks are encoded is beneficially considerably less than a number of levels present in the data blocks 40 prior to being encoded, for example beneficially at least 3 times less, more beneficially at least 5 times less, and yet more beneficially at least 10 times less. The number of levels present in the data blocks prior to being encoded in the second stage 50 is referred to as being the original number of levels, namely is a measure of dynamic levels present in the data blocks 40, for example representative of image-, video-, audio- or graphics-content. For example, referring to FIG. 4, an image field 200 includes 1000×1000 pixels points in a 2-dimensional array, wherein the image field 200 is subdivided in the first stage 30 of the encoder 10 into 100 data blocks 40, denoted by 210, wherein each block 210 corresponds to 100×100 pixels, namely 10,000 pixels in total. Each pixel is represented in colour and/or intensity by 8 binary bits defining 256 levels of dynamic range. When the encoding unit 110(i) encodes a given block 210, the number of levels is reduced, for example, in a range of 2 to 8, together with supplementary data as will be described later. In a event that the encoding unit 110(i) employs more than, for example, 8 levels, the encoding unit 110(i) becomes less efficient at providing data compression, requiring use of pre-processing of the image 200, for example predictive coding or delta coding, prior to data being presented to the second stage 50.

The encoding algorithm employed in the encoding unit 110(i) is optionally employed for encoding a greyscale image or other information that only uses one channel. Moreover, the encoding algorithm employed in the encoding unit 110(i) is optionally employed for colour images or other multichannel content. Multichannel content, for example 3-D colour images, are optionally encoded so that all the channels are compressed similarly, or alternatively are optionally encoded in mutually different manners, for example data blocks of audio channels are optionally encoded in a different manner to data blocks of video channels. In an event that the channels are encoded in a mutually different manner, different coding algorithms in the encoder units 110 and different sizes of the data blocks 40 can be employed; the selection of data block 40 sizes is, as aforementioned, optionally implemented on a basis of type of content present in the input data 20.

The encoding algorithm employed in the encoding unit 110(i) will now be described in greater detail with reference to FIG. 5. In FIG. 5, an example original data block 40 is denoted by 300. The data block 300 includes 4×4 pixels having greyscale values as shown. Beneficially, the data block 300 is susceptible to being encoded efficiently in the encoding unit 110(i) using an algorithm pursuant to the present invention, with a small coding error occurring during encoding.

When applying the algorithm, a mean value for all pixels or elements in the block 300 is computed in computing hardware or dedicated digital hardware of the encoder 10:

$$MeanAll = \frac{( \begin{matrix}10 + 9 + 10 + 172 + 173 + 10 + 9 + 8 + \\ 9 + 173 + 8 + 10 + 172 + 174 + 9\end{matrix} )}{16}$$

$$\frac{965}{16} = 60.3125$$

Next, the algorithm defines two sets of levels, namely Level_{—}0 and Level_{—}1, wherein the set Level_{—}0 includes all pixels whose values are below MeanAll, and the set Level_{—}1 includes all pixels whose values are equal to or above MeanAll. The pixels of the data block 300 are then mapped onto a corresponding data block 320 in FIG. 6, wherein spatial locations of the pixels are retained but they are now represented by merely two levels corresponding to the sets Level_{—}0 and Level_{—}1. For each of the sets of levels, namely Level_{—}0 and Level_{—}1, mean values are computed in the aforesaid computing hardware or dedicated digital hardware:

$$MeanLevel\_ 0 = \frac{( 10 + 9 + 10 + 9 + 19 + 9 + 8 + 9 + 8 + 10 + 9 )}{11} = \frac{101}{11} = 9.1818$$

$$MeanLevel\_ 1 = \frac{( 172 + 173 + 173 + 172 + 174 )}{5} = \frac{864}{5} = 172.8$$

Thereafter, when executing the algorithm, a spatial representation of the pixels in the data block 320 is stored as a pixel mask, together with mean values for each of the sets of levels, namely MeanLevel_{—}0 and Mean Level_{—}1; alternatively, instead of storing in data memory, such data is streamed from the encoder unit 110(i). Although a geometric mean computation is described in the foregoing for the algorithm, it will be appreciated that other types of averaging summation computation are possible, for example a skewed mean, an asymmetrical mean, a logarithmic mean. Optionally, the values for each of the set of levels can be calculated using any calculating means, for example dedicated digital hardware and/or a computing device executing software products. From a point of view of the decoder, a method of calculation employed is not a key issue. Optional examples of computing means include “brute force” methods. Monte Carla methods and so forth, to find optimum number of levels and values for the set of levels. Example optimization can be Rate-Distortion optimization to determine how many bits should be used during coding and how much error is allowed for the coded information. Instead of outputting from the algorithm, one mean value is optionally output from a reference one of the sets, and a difference value for the other set relative to the reference set, for example 9.1818 and (172.8−9.1818). Optionally, the mean values as computed above are quantized, for example to nearest integer values, in order to obtain a higher degree of data compression in output data from the encoder unit 110(i). Optionally, a degree of quantization employed is a dynamic function of how many sets are required to represent the data block 300. Quantization to nearest integer for the example above provides MeanLevel_{—}0=9, and MeanLevel_{—}0=173.

When generating output data from the encoder unit 110(i), a spatial representation of the pixels, namely a mask, is output, based upon the data block 320, in a plurality of potential scanning orders, for example left-to-right and top-to-bottom as illustrated in FIG. 6, in a zig-zag manner, maze or similar. In an example, the mask is output left-to-right and top-to-bottom such that mask is expressed in output data from the encoder unit 110(i) as 0000 1100 0010 0110.

When the encoder 10 is employed to encode video content, a sequence of images is presented to the encoder 10, wherein each image is susceptible to being broken down into data blocks 40 which are then encoded using the encoder units 110 as appropriate depending upon their content. Beneficially, as aforementioned, the encoder 10 switches dynamically between the different encoder units 110 depending upon a nature of data blocks presented to the second stage 50 for encoding. The choice of encoder units 110 is, as aforementioned, recorded in the encoded output data from the second stage 50. The third stage 60 optionally applies further encoding and/or compression, for example using one or more of DPCM (“differential pulse-code modulation”), RLE (“run-length encoding”), arithmetic coding, delta coding, VLC (“Variable-length coding”), Lempel-Ziv coding methods (such as ZLIB, LZO, LZSS, LZ77), Burrow-Wheeler transform based coding methods (such as RLE, BZIP2) and Huffman coding. Delivery of the mask, namely scanning order for data output from the second stage 50, is beneficially implemented via a database, for example as described in a United States patent application no. US2010/0322301 (“Image processor, image generator and computer program”, Applicant—Gurulogic Microsystems Oy, Inventor—Tuomas Kärkkäinen) which is hereby incorporated by reference. Use of such a database for providing a path by which the mask is communicated to a corresponding decoder is capable of providing a form of access key, for example for hindering unauthorized distribution of encoded content in encoded form (i.e. unauthorized file sharing).

A regenerated decoded version of the data block 300 of FIG. 5 is illustrated in FIG. 7 and indicated by 500. This regenerated data block 500 corresponds to a portion of the decoded output data 75 provided from the decoder 25. It will be appreciated that only minor loss of information present in the data block 500 occurs relative to the original data block 40, 300 which is input to the encoder 10.

The encoder 10 and/or or decoder 25 are beneficially implemented using dedicated electronic hardware, for example a custom digital integrated circuit, a field-programmable gate array (FPGA) or similar. Alternatively, or additionally, the encoder 10 and/or the decoder 25 can be implemented by executing one or more software products, stored on machine-readable data storage media, on computing hardware coupled in data communication with data memory. Optionally, the computing hardware is implemented as a high-speed reduced-instruction-set (RISC) processor. The encoded output data 70 is optionally one or more of: streamed, stored on a data carrier such as an optically-readable disc, stored in data memory and so forth.

Modifications to embodiments of the invention described in the foregoing are possible without departing from the scope of the invention as defined by the accompanying claims. Expressions such as “including”, “comprising”, “incorporating”, “consisting of” “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

We claim:

1. An encoder for encoding input data to generate corresponding encoded output data, characterized in that the encoder includes:
an analysis unit for analysing one or more portions of the input data and directing the one or more portions to appropriate one or more encoding units, wherein the one or more encoding units are operable to encode the one or more portions thereat to generate the encoded output data, wherein,
at least one of the one or more encoding units is operable to compute data values present in each portion received thereat, to subdivide the data values into at least two sets, to compute values of the data values in each set, and for each set to allocate the value for that set to all data values in that set, whilst retaining a spatial mask of the portion, and wherein the spatial mask and information representative of the values computed for the at least two data sets is included in the encoded output data.

2. The encoder as claimed in claim 1, characterized in that the encoder includes an output encoder unit for receiving encoded output data from the one or more encoding units and for further encoding this encoded output data to generate the encoded output data from the encoder.

3. The encoder as claimed in claim 1, characterized in that the encoder further includes an input stage for partitioning the input data into one or more portions when the input data is not already subdivided into one or more portions.

4. The encoder as claimed in claim 1, characterized in that the value is at least one of: an average, an arithmetic average, a skewed average, a logarithmic average, weighted average.

5. The encoder as claimed in claim 1, characterized in that the at least one of the one or more encoding units is operable to subdivide the data values present in each portion into a range of 2 to 8 data sets, or 2 or more data sets.

6. The encoder as claimed in claim 1, characterized in that the encoder is operable to store information representative the one or more masks of the one or more portions in a remote database for access by one or more decoders when decoding the encoded output data generated by the encoder.

7. A method of encoding input data to generate corresponding encoded output data, characterized in that the method includes:
(a) using an analysis unit for analysing one or more portions of the input data and directing the one or more portions to appropriate one or more encoding units, wherein the one or more encoding units are operable to encode the one or more portions thereat to generate the encoded output data; and
(b) using at least one of the one or more encoding units to compute data values present in each portion received thereat, to subdivide the data values into at least two sets, to compute values of the data values in each set, and for each set to allocate the value for that set to all data values in that set, whilst retaining a spatial mask of the portion, and wherein the spatial mask and information representative of the values computed for the at least two data sets is included in the encoded output data.

8. The method as claimed in claim 7, characterized in that the method includes using an output encoder unit for receiving encoded output data from the one or more encoding units and for further encoding this encoded output data to generate the encoded output data.

9. The method as claimed in claim 7, characterized in that the method includes employing an input stage for partitioning the input data into one or more portions when the input data is not already subdivided into one or more portions.

10. The method as claimed in claim 7, characterized in that the value is at least one of: an average, an arithmetic average, a skewed average, a logarithmic average, weighted average.

11. The method as claimed in claim 7, characterized in that the method includes using at least one of the one or more encoding units to subdivide the data values present in each portion into a range of 2 to 8 data sets, or 2 or more data sets.

12. The method as claimed in claim 7, characterized in that the method includes storing information representative the one or more masks of the one or more portions in a remote database for access by one or more decoders when decoding the encoded output data.

13. The method as claimed in claim 7, characterized in that the encoded output data is further encoded and/or compressed.

14. The method as claimed in claim 13, characterized in that the further encoding and/or compression includes at least one of: DPCM (“differential pulse-code modulation”), RLE (“run-length encoding”), arithmetic encoding, delta, coding, VLC (“Variable-Length Coding”), Lempel-Ziv coding (ZLIB, LZO, LZSS, LZ77), Burrow-Wheeler transform-based coding (RLE, BZIP2), Huffman coding.

15. A decoder for decoding encoded input data to generate corresponding decoded output data, characterized in that the decoder includes:
an analysis unit for analysing one or more portions of the input data and directing the one or more portions to appropriate one or more decoding units, wherein the one or more decoding units are operable to decode the one or more portions thereat for generating the decoded output data, wherein,
at least one of the one or more decoding units is operable to extract a spatial mask and information representative of values for at least two data sets included in the encoded input data, and for assigning values to elements in the mask pursuant to which of the sets the elements belong as defined by the mask.

16. The decoder as claimed in claim 15, characterized in that the decoder includes an output decoder unit for receiving decoded output data from the one or more decoding units and for further decoding this encoded output data to generate the decoded output data from the decoder.

17. The decoder as claimed in claim 15, characterized in that the decoder further includes an input stage for extracting from the encoded input data one or more portions for directing as defined by encoding parameters present in the encoded input data to one or more decoding units.

18. The decoder as claimed in claim 15, characterized in that the at least one of the one or more decoding units is operable to assign values to elements of the mask corresponding the data sets, wherein there are in a range of 2 to 8 data sets, or 2 or more data sets.

19. The decoder as claimed in claim 15, characterized in that the decoder is operable to retrieve information representative the one or more masks of the one or more portions from a remote database when decoding the encoded input data generated by an encoder.

20. A method of decoding encoded input data to generate corresponding decoded output data, characterized in that the method includes:
(a) using an analysis unit for analysing one or more portions of the encoded input data and directing the one or more portions to appropriate one or more decoding units, wherein the one or more decoding units are operable to decode the one or more portions thereat for generating the decoded output data; and
(b) using at least one of the one or more decoding units to extract a spatial mask and information representative of values computed for at least two data sets included in the encoded input data, and to assign values to elements in the mask pursuant to which of the sets the elements belong as defined by the mask.

21. The method as claimed in claim 20, characterized in that the method includes using an output decoder unit for receiving decoded output data from the one or more decoding units and for further decoding this encoded output data to generate the decoded output data.

22. The method as claimed in claim 20, characterized in that the method further includes using an input stage for extracting from the encoded input data one or more portions for directing as defined by encoding parameters present in the encoded input data to one or more decoding units.

23. The method as claimed in claim 20, characterized in that the at least one of the one or more decoding units is operable to assign values to elements of the mask corresponding the data sets, wherein there are in a range of 2 to 8 data sets, or 2 or more data sets.

24. The method as claimed in claim 20, characterized in that the method includes retrieving information representative the one or more masks of the one or more portions from a remote database when decoding the encoded input data generated by an encoder.

25. A data communication system, comprising:
an encoder for encoding input data to generate corresponding encoded output data, the encoder including:
an analysis unit for analysing one or more portions of the input data and directing the one or more portions to appropriate one or more encoding units, wherein the one or more encoding units are operable to encode the one or more portions thereat to generate the encoded output data, wherein,
at least one of the one or more encoding units is operable to compute data values present in each portion received thereat, to subdivide the data values into at least two sets, to compute values of the data values in each set, and for each set to allocate the value for that set to all data values in that set, whilst retaining a spatial mask of the portion, and wherein the spatial mask and information representative of the values computed for the at least two data sets is included in the encoded output data; and
a decoder for decoding the encoded input data to generate corresponding decoded output data, characterized in that the decoder includes:
a further analysis unit for analysing one or more portions of the input data and directing the one or more portions to appropriate one or more decoding units, wherein the one or more decoding units are operable to decode the one or more portions thereat for generating the decoded output data, wherein,
at least one of the one or more decoding units is operable to extract a spatial mask and information representative of values for at least two data sets included in the encoded input data, and for assigning values to elements in the mask pursuant to which of the sets the elements belong as defined by the mask.

26. A method of communicating data in the data communication system as claimed in claim 25, wherein the method comprises:
encoding input data to generate corresponding encoded output data, including:
using an analysis unit for analysing one or more portions of the input data and directing the one or more portions to appropriate one or more encoding units, wherein the one or more encoding units are operable to encode the one or more portions thereat to generate the encoded output data, and
using at least one of the one or more encoding units to compute data values present in each portion received thereat, to subdivide the data values into at least two sets, to compute values of the data values in each set, and for each set to allocate the value for that set to all data values in that set, whilst retaining a spatial mask of the portion, and wherein the spatial mask and information representative of the values computed for the at least two data sets is included in the encoded output data; and
decoding the encoded input data to generate corresponding decoded output data, including:
using a further analysis unit for analysing one or more portions of the encoded input data and directing the one or more portions to appropriate one or more decoding units, wherein the one or more decoding units are operable to decode the one or more portions thereat for generating the decoded output data, and
using at least one of the one or more decoding units to extract a spatial mask and information representative of values computed for at least two data sets included in the encoded input data, and to assign values to elements in the mask pursuant to which of the sets the elements belong as defined by the mask.

27. A non-transitory machine-readable data storage media comprising a software product stored thereon, characterized in that the software product is executable upon computing hardware for executing the method as claimed in claim 7.

28. A non-transitory machine-readable data storage media comprising a software product stored thereon, characterized in that the software product is executable upon computing hardware for executing the method as claimed in claim 20.
